(19) United States
(12) Patent Application Publication
(10) Pub. No.: US 2015/0108793 A1
(43) Pub. Date: Apr. 23, 2015

(54) CARBON FIBER CROSS MEMBER FOR AUTOMOTIVE CHASSIS STRUCTURE

(71) Applicant: GM GLOBAL TECHNOLOGY OPERATIONS LLC, Detroit, MI (US)

(72) Inventors: Len V. Peschansky, West Bloomfield, MI (US); Frank Burger, Ortonville, MI (US); Joseph M. Madafferi, South Lyon, MI (US); Yutaka Yagi, Shelby Township, MI (US)

(73) Assignees: TEIJIN LIMITED, Osaka (JP); GM GLOBAL TECHNOLOGY OPERATIONS LLC, Detroit, MI (US)

(21) Appl. No.: 14/058,656

(22) Filed: Oct. 21, 2013

(51) Int. Cl. B62D 29/04

(52) U.S. Cl. CPC B62D 29/041
USPC 296/204; 296/205

(57) ABSTRACT

A cross member for an automotive chassis structure includes a first portion and a second portion. The first portion extends along a longitudinal axis, and includes a generally U-shaped cross section perpendicular to the longitudinal axis. The second portion extends along the longitudinal axis, and includes a generally inverted U-shaped cross section perpendicular to the longitudinal axis. The first portion and the second portion are attached together to define a tubular structure that extends along the longitudinal axis, and defines a hollow interior region. The first portion and the second portion each include and are manufactured from a thermoplastic material reinforced with carbon fiber.

### TECHNICAL FIELD

The invention generally relates to a cross member for an automotive chassis structure.

### BACKGROUND

An automotive chassis structure may include a cross member that extends laterally between two longitudinal frame rails. Often, the cross member is used to support a transmission, as well as provide lateral support to the longitudinal frame rails. The cross member must provide the required tensile and flexure strength, at a minimal weight, in order to improve fuel efficiency of the vehicle.

### SUMMARY

A cross member for an automotive chassis structure is provided. The cross member includes a first portion and a second portion. The first portion extends along a longitudinal axis, and includes a generally U-shaped cross section perpendicular to the longitudinal axis. The second portion extends along the longitudinal axis, and includes a generally inverted U-shaped cross section perpendicular to the longitudinal axis. The first portion and the second portion are attached together to define a tubular structure that extends along the longitudinal axis, and defines a hollow interior region. The first portion and the second portion each include and are manufactured from a thermoplastic resin material reinforced with carbon fiber.

Because the cross member is manufactured from the thermoplastic resin material that is reinforced with the carbon fiber, the cross member is lighter than similarly sized and shaped members manufactured from steel or other metals, while still providing the required tensile and flexural strength. Furthermore, because the cross member is manufactured from the thermoplastic resin material that is reinforced with carbon fiber, the shape of the cross member may vary to optimize the required stiffness and/or strength in various regions of the cross member.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a cross member for an automotive chassis structure.

FIG. 2 is a schematic side view of the cross member.

FIG. 3 is a schematic top view of the cross member.

FIG. 4 is a schematic cross sectional view of the cross member taken along a longitudinal axis of the cross member.

FIG. 5 is a schematic cross sectional view of the cross member taken perpendicular to the longitudinal axis at a first location.

FIG. 6 is a schematic cross sectional view of the cross member taken perpendicular to the longitudinal axis at a second location.

FIG. 7 is a schematic cross sectional view of the cross member taken perpendicular to the longitudinal axis at a third location.

FIG. 8 is a schematic enlarged cross sectional view of the cross member.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be realized by any number of hardware, software, and/or firmware components configured to perform the specified functions.

Referring to the Figures, wherein like numerals indicate like parts throughout the several views, a cross member is generally shown at 20. The cross member 20 is for an automotive chassis structure. The cross member 20 is attached at each axial end thereof to a frame rail (not shown) of the chassis structure.

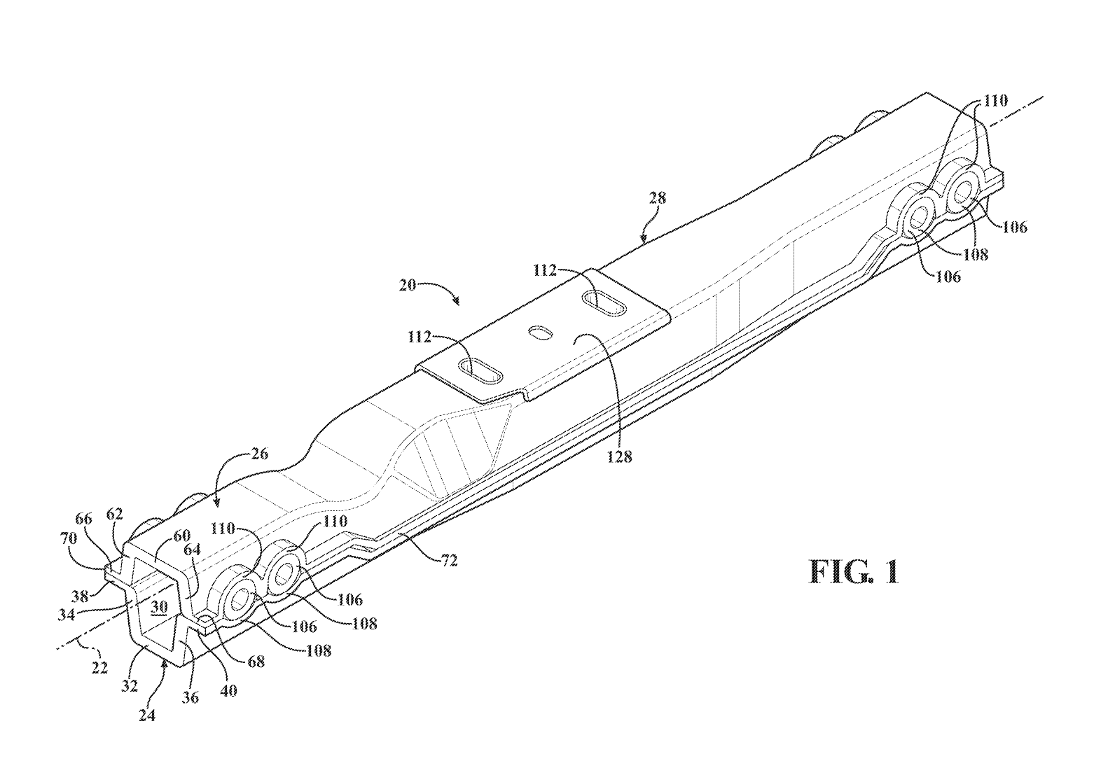

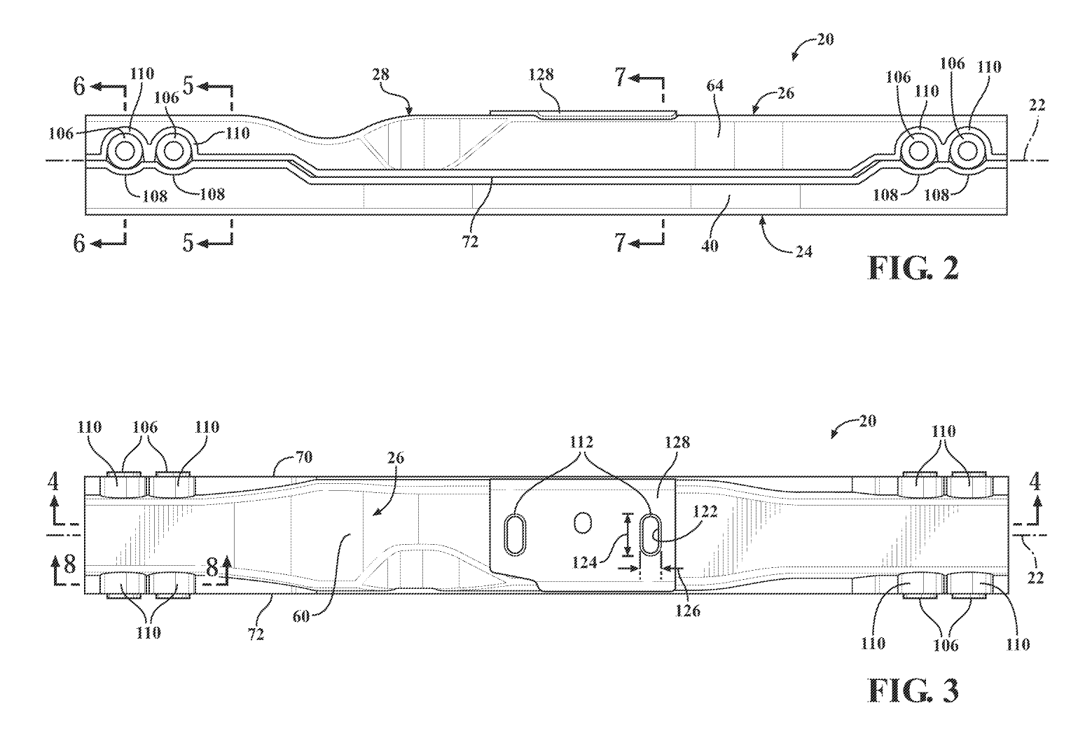

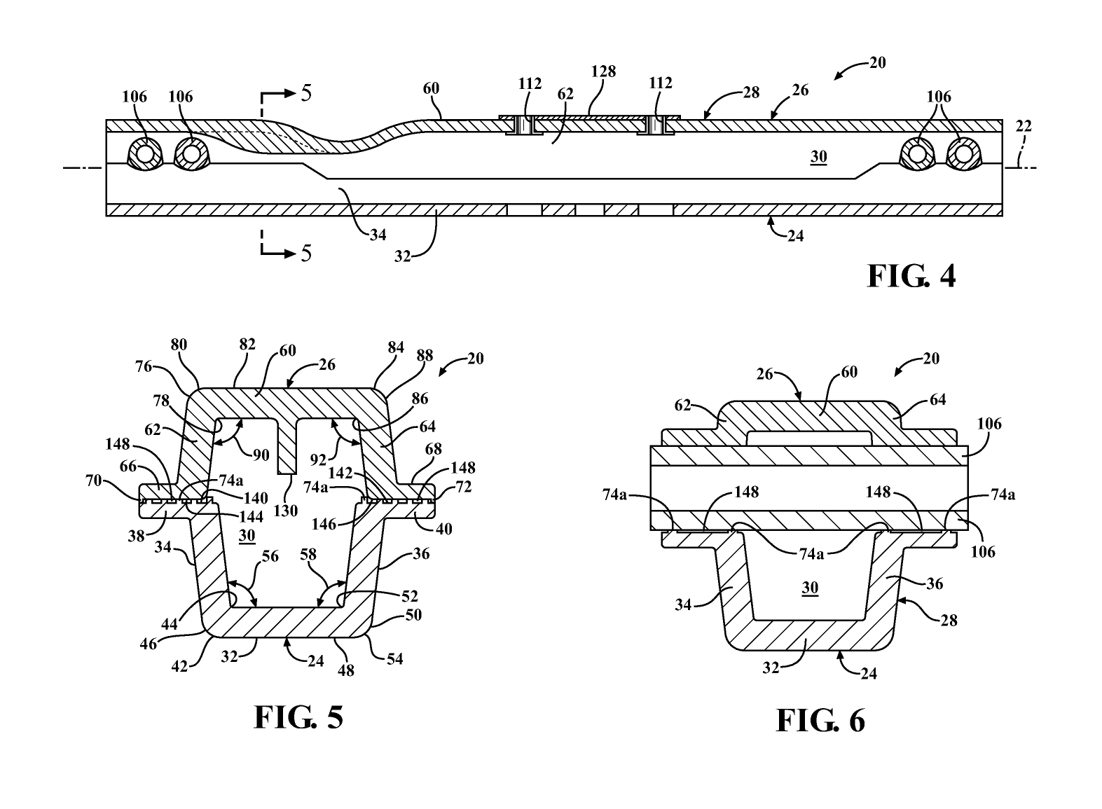

Referring to FIGS. 1 through 5, the cross member 20 extends along a longitudinal axis 22, and includes a first portion 24 and a second portion 26. The first portion 24 extends along the longitudinal axis 22, and includes a generally U-shaped cross section perpendicular to the longitudinal axis 22. The second portion 26 extends along the longitudinal axis 22, and includes a generally inverted U-shaped cross section perpendicular to the longitudinal axis 22. The first portion 24 and the second portion 26 are attached together to define a tubular structure 28 that extends along the longitudinal axis 22 and defines a hollow interior region 30.

The first portion 24 and the second portion 26 each include and are manufactured from a thermoplastic resin reinforced with carbon fiber, often referred to as a carbon fiber material. Preferably, the carbon fiber includes a length of between 3.0 and 100 mm. The carbon fiber may be configured as a highly planar oriented random mat. Additionally, a uni-directional oriented fiber layer may also be included. Preferably, the first portion 24 and the second portion 26 are each individually manufactured from a compression molding process. The thermoplastic resin reinforced with the carbon fiber includes a tensile strength of at least 200 MPa, and a flexural strength of at least 300 MPa.

The type of carbon fiber may include short length fibers (0.1-10 mm), long length fibers (10-100 mm), or continuous fibers (>100 mm), and may include a combination thereof. Preferably long length fibers are used due to their good balance of mold-ability/productivity/mechanical performance. The carbon fibers may be configured in a random-oriented or specific-direction-oriented manner. In addition, the fiber mat may be highly planar oriented or uni-directional oriented or the combination thereof. Preferably, the fiber mat is random-oriented fiber due to the good balance of mold-ability/productivity/mechanical performance. In addition, a uni-directional oriented carbon fiber layer may be included in order to enhance local stiffness & strength at certain area.

The carbon fiber reinforced plastic material may be a lamination of a fiber reinforced layer and a resin layer. The thermoplastic resin may include any suitable kind of thermoplastic resin. For example, the thermoplastic resin may include but is not limited to: vinyl chloride resin, vinylidene chloride resin, vinyl acetate resin, polyvinyl alcohol resin, polystyrene resin, acrylonitrile styrene resin, acrylonitrile butadiene styrene resin, acrylic resin, metacrylate resin, polyethylene resin, polypropylene resin, polyamide resin (PA6, PA11, PA12, PA46, PA66, PA610), polyacetal resin, polycarbonate resin, polyethylene terephthalate resin, polyethylene naphthalate resin, polybutylene terephthalate resin, polyarylate resin, polyphenylene ether resin, polyphenylene sulfide resin, polysulfone resin, polyether sulfone resin, polyether ether ketone resin, polylactic resin, or a compound of more than 2 types of the above noted resins. The carbon fiber reinforced plastic may further include functional filler or additive agents like organic/inorganic filler, fire-retardant, anti-UV agent, colorant, mold release agent, softener, plasticizing agent, surface acting agent etc.

The first portion 24 and the second portion 26 may be attached together in any suitable manner capable of attaching carbon fiber components together. For example, the first portion 24 and the second portion 26 may be attached together by one of an ultrasonic welding process, an adhesive bonding process, a mechanical fastening process, a vibration welding process, a heat welding process, a solvent welding process, or a combination thereof.

Referring to FIG. 5, the first portion 24 includes a bottom wall 32, a first side wall 34, and a second side wall 36. The first side wall 34 and the second side wall 36 of the first portion 24 extend from opposing lateral edges of the bottom wall 32 to distal edges thereof respectively. The first portion 24 includes a first side flange 38 that extends from the distal edge of the first side wall 34 of the first portion 24. The first side flange 38 extends outward and away from the interior region 30 of the tubular structure 28. The first portion 24 includes a second side flange 40 that extends from the distal edge of the second side wall 36. The second side flange 40 extends outward and away from the interior region 30 of the tubular structure 28.

The first portion 24 includes a first corner 42 that is disposed at the intersection of the bottom wall 32 and the first side wall 34. The first corner 42 defines a first interior radius 44 that is disposed within the interior region 30 of the tubular structure 28, and a first exterior radius 46 that is disposed along an exterior surface 48 of the first portion 24. The first portion 24 includes a second corner 50 that is disposed at the intersection of the bottom wall 32 and the second side wall 36. The second corner 50 defines a second interior radius 52 that is disposed within the interior region 30 of the tubular structure 28, and a second exterior radius 54 that is disposed along the exterior surface 48 of the first portion 24. Because the first portion 24 is manufactured from the compression molded carbon fiber plastic, the first interior radius 44 and the first exterior radius 46 may vary independently of each other. Accordingly, the value of the first interior radius 44 is not dependent upon the value of the first exterior radius 46, nor is the value of the first exterior radius 46 dependent upon the value of the first interior radius 44. Similarly, the second interior radius 52 and the second exterior radius 54 may vary independently of each other as well.

The first portion 24 defines a first angle 56 that is formed within the interior region 30 between the bottom wall 32 and the first side wall 34 of the first portion 24. The value of the first angle 56 is greater than ninety degrees (90°). Preferably, the value of the first angle 56 is between the range of ninety degrees (90°) and one hundred thirty five degrees (135°), and more preferably is between the range of ninety degrees (90°) and ninety five degrees (95°). The first portion 24 further defines a second angle 58 that is formed within the interior region 30 between the bottom wall 32 and the second side wall 36 of the first portion 24. The value of the second angle 58 is greater than ninety degrees (90°). Preferably, the value of the second angle 58 is between the range of ninety degrees (90°) and one hundred thirty five degrees (135°), and more preferably is between the range of ninety degrees (90°) and ninety five degrees (95°). While the first angle 56 and the second angle 58 are shown as having identical values in the Figures, it should be appreciated that the value of the first angle 56 may differ from the value of the second angle 58, i.e., the value of the first angle 56 and the second angle 58 of the first portion 24 may each include a non equal value.

The second portion 26 includes a top wall 60, a third side wall 62, and a fourth side wall 64. The third side wall 62 and the fourth side wall 64 of the second portion 26 extend from opposing lateral edges of the top wall 60 to distal edges thereof respectively. The second portion 26 includes a third side flange 66 that extends from the distal edge of the third side wall 62 of the second portion 26. The third side flange 66 extends outward and away from the interior region 30 of the tubular structure 28. The second portion 26 includes a fourth side flange 68 that extends from the distal edge of the fourth side wall 64 of the second portion 26. The fourth side flange 68 extends outward and away from the interior region 30 of the tubular structure 28.

The first side flange 38 of the first portion 24 and the third side flange 66 of the second portion 26 are disposed in abutting engagement to define a first flange joint 70. Similarly, the second side flange 40 of the first portion 24 and the fourth side flange 68 of the second portion 26 are disposed in abutting engagement to define a second flange joint 72. The first portion 24 and the second portion 26 are attached to each other along the first flange joint 70 and the second flange joint 72. As such, the first flange joint 70 and the second flange joint 72 provide the required surface area contact for attaching the carbon fiber first portion 24 and the carbon fiber second portion 26 together.

The first side flange 38 and the second side flange 40 of the first portion 24 may include at least one ridge 74 for engaging the third side flange 66 and the fourth side flange 68 of the second portion 26 respectively. Alternatively, the third side flange 66 and the fourth side flange 68 of the second portion 26 may include at least one ridge 74 for engaging the first side flange 38 and the second side flange 40 of the first portion 24 respectively. It should be appreciated that all of the first side flange 38, the second side flange 40, the third side flange 66 and the fourth side flange 68 may include one or more ridges 74. The ridges 74 on the side flanges strengthen the attachment between the first portion 24 and the second portion 26 along the first flange joint 70 and the second flange joint 72. The ridges 74 may function as a spacer to keep an appropriate gap for an adhesive. Additionally, if a welding process, such as but not limited to a vibration welding process or an ultrasonic welding process is used to attach the side flanges, then the ridges 74 may function as an energy director, and may be partially melted away to form the connection between the first portion 24 and the second portion 26. As used herein, the term “energy director” is defined as a feature that limits initial contact to a small area, which focuses welding energy to get a more stable and constant melting of the material, or a feature that operates as a dimension adjuster to change a dimension of an object by melting.

The second portion 26 includes a third corner 76 that is disposed at the intersection of the top wall 60 and the third side wall 62. The third corner 76 defines a third interior radius 78 disposed within the interior region 30 of the tubular structure 28, and a third exterior radius 80 disposed along an exterior surface 82 of the second portion 26. The second portion 26 further includes a fourth corner 84 that is disposed at the intersection of the top wall 60 and the fourth side wall 64. The fourth corner 84 defines a fourth interior radius 86 disposed within the interior region 30 of the tubular structure 28, and a fourth exterior radius 88 that is disposed along the exterior surface 82 of the second portion 26. Because the second portion 26 is manufactured from the compression molded carbon fiber material, the third interior radius 78 and the third exterior radius 80 may vary independently of each other. Accordingly, the value of the third interior radius 78 is not dependent upon the value of the third exterior radius 80, nor is the value of the third exterior radius 80 dependent upon the value of the third interior radius 78. Similarly, the fourth interior radius 86 and the fourth exterior radius 88 may vary independently of each other as well.

The second portion 26 defines a third angle 90 that is formed within the interior region 30 between the top wall 60 and the third side wall 62 of the second portion 26. The value of the third angle 90 is greater than ninety degrees (90°). Preferably, the value of the third angle 90 is between the range of ninety degrees (90°) and one hundred thirty five degrees (135°), and more preferably is between the range of ninety degrees (90°) and ninety five degrees (95°). The second portion 26 further defines a fourth angle 92 that is formed within the interior region 30 between the top wall 60 and the fourth side wall 64 of the second portion 26. The value of the fourth angle 92 is greater than ninety degrees (90°). Preferably, the value of the fourth angle 92 is between the range of ninety degrees (90°) and one hundred thirty five degrees (135°), and more preferably is between the range of ninety degrees (90°) and ninety five degrees (95°). While the third angle 90 and the fourth angle 92 are shown as having identical values in the Figures, it should be appreciated that the value of the third angle 90 may differ from the value of the fourth angle 92, i.e., the value of the third angle 90 and the fourth angle 92 of the second portion 26 may each include a non equal value.

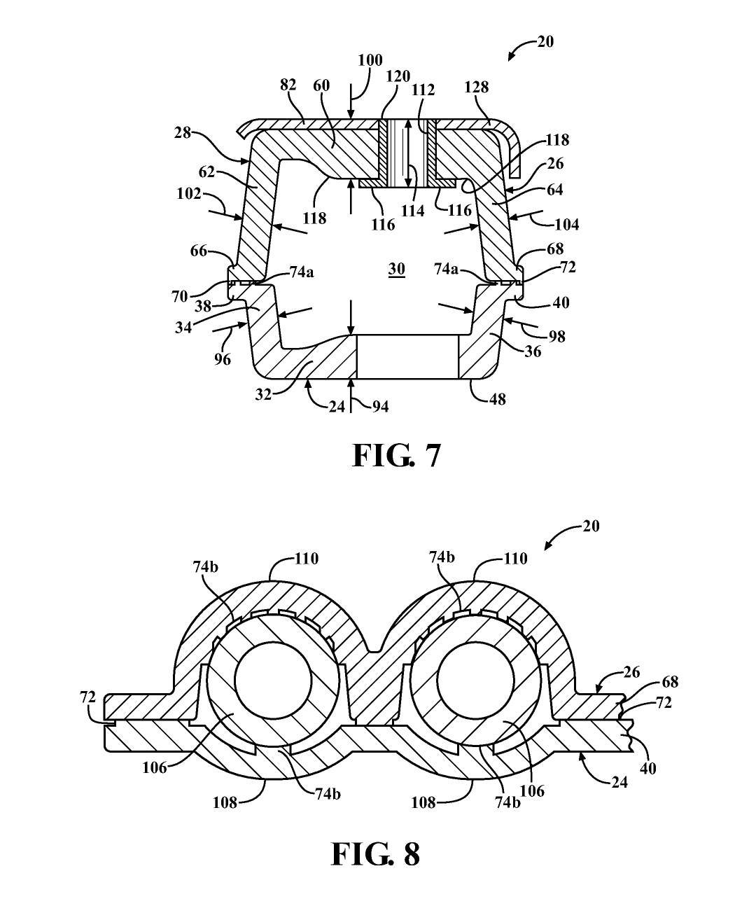

Because both the first portion 24 and the second portion 26 are manufactured from the compression molded carbon fiber material, at least one of the first portion 24 and the second portion 26 may include a wall thickness that may vary in either an axial direction along the longitudinal axis 22, or a transverse direction perpendicular to the longitudinal axis, or may vary simultaneously in both the axial direction along the longitudinal axis 22, and the transverse direction perpendicular to the longitudinal axis 22. Referring to FIG. 7, the wall thickness of the first portion 24 includes a wall thickness 94 of the bottom wall 32, a wall thickness 96 of the first side wall 34, and a wall thickness 98 of the second side wall 36. The wall thickness of the second portion 26 includes a wall thickness 100 of the top wall 60, a wall thickness 102 of the third side wall 62, and a wall thickness 104 of the fourth side wall 64. Any of the various wall thicknesses may vary in thickness either in the axial direction or the transverse direction, and preferably in both the axial direction and the transverse direction simultaneously. For example, as the wall thickness 94 of the bottom wall 32 changes with a change in location along the longitudinal axis 22, i.e., in the axial direction, the wall thickness 94 of the bottom wall 32 may also change with a change in the lateral location of the bottom wall 32, i.e., the transverse direction. Preferably, the wall thickness 94, 96, 98 of the first portion 24 and the wall thickness 100, 102, 104 of the second portion 26 includes a maximum variation of ten millimeters (10 mm). Also preferably, the wall thickness 94, 96, 98 of the first portion 24 and the wall thickness 100, 102, 104 second portion 26 is variable between a minimum thickness of one and one half millimeters (1.5 mm) and a maximum thickness of eleven and one half millimeters (11.5 mm). Furthermore, the wall thickness 94 of the bottom wall 32 may be different than the wall thickness 96 of the first side wall 34 and/or the wall thickness 98 of the second side wall 36. Similarly, the wall thickness 100 of the top wall 60 may be different than the wall thickness 102 of the third side wall 62 and/or the wall thickness 104 of the fourth side wall 64.

Referring to FIGS. 6 and 8, the cross member 20 includes at least one metal spacer 106 disposed between and attached to both the first portion 24 and the second portion 26. Preferably, and as shown, the cross member 20 includes a pair of metal spacers 106 at each axial end of the cross member 20. Each of the metal spacers 106 extends transverse to the longitudinal axis 22, between the first flange joint 70 and the second flange joint 72. The metal spacers 106 extend transversely beyond the first flange joint 70 and the second flange joint 72 to resist lateral compression of the tubular structure 28. Preferably, the metal spacer 106 is manufactured from aluminum, but it should be appreciated that the metal spacer 106 may be manufactured from some other metal.

Referring to FIG. 8, the first side wall 34 and the second side wall 36 of the first portion 24 each define a concave section 108 supporting one of the metal spacers 106 therein. The third side wall 62 and the fourth side wall 64 of the second portion 26 each define a convex section 110 supporting one of the metal spacers 106 therein. Accordingly, each of the metal spacers 106 is cradled by and disposed between a respective one of the concave sections 108 and the convex sections 110. At least one of the respective convex sections 110 and the concave sections 108 includes at least one ridge 74 for engaging the metal spacer 106. The ridge 74 operates to strengthen the attachment between the first portion 24 and the metal spacer 106, and between the second portion 26 and the metal spacer 106. In order to enhance the compression strength of the cross member 20, the centerline of the metal spacers 106 and the joining surfaces between the first flange joint 70 and the second flange joint 72 are offset to reduce excessive peel stress of the joining area generated by any compression load to the cross member 20.

Referring to FIG. 7, a metal insert 112 is disposed within and supported by the top wall 60 of the second portion 26. The metal insert 112 is preferably manufactured from aluminum. The metal insert 112 includes a length 114 perpendicular to the top wall 60 that is equal to or greater than the wall thickness 100 of the top wall 60. As such, the metal insert 112 includes a lower surface 116 that is disposed within the interior region 30 that extends downward below an interior surface 118 of the top wall 60. The metal insert 112 includes an upper surface 120 that extends upward above the exterior surface 82 of second portion 26. The metal insert 112 operates to restrict compression of the top wall 60. Referring to FIG. 3, the metal insert 112 defines an oblong opening 122 to allow passage of a bolt or other similar fastener therethrough. The oblong opening 122 includes a long dimension 124 disposed perpendicular to the longitudinal axis 22 and parallel with the top wall 60, and a short dimension 126 that is disposed parallel with the longitudinal axis 22 and parallel with the top wall 60.

The cross member 20 may be used to support a transmission or other structure of the vehicle. Accordingly, as best shown in FIG. 7, the cross member 20 may be equipped with a metal plate 128 that is attached to the exterior surface 82 of the top wall 60 of the second portion 26, in the general area of and surrounding the metal insert 112. The metal plate 128 may be attached to the cross member 20 in any suitable manner. Preferably, the metal plate 128 is manufactured from aluminum, but it should be appreciated that the metal plate 128 may be manufactured from some other metal.

Referring to FIG. 5, the cross member 20 may include at least one rib 130 that extends from at least one of the first portion 24 and/or the second portion 26 inward into the interior region 30 of the tubular structure 28. The rib 130 may be arranged to extend parallel with the longitudinal axis 22, transverse to the longitudinal axis 22, or be angled relative to the longitudinal axis 22. It should be appreciated that the cross member 20 may include multiple ribs 130 formed into both the upper portion and the lower portion to increase the strength of the cross member 20. The rib 130 is effective to enhance both the strength and the stiffness of the cross member 20.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A cross member for an automotive chassis structure, the cross member comprising:
a first portion having a bottom wall, a first side wall, and a second side wall, each extending along a longitudinal axis, and with the first side wall and the second side wall connected to the bottom wall to form a generally U-shaped cross section generally perpendicular to the longitudinal axis such that the first side wall and the second side wall extend from the bottom wall to a first distal edge and a second distal edge respectively; and
a second portion opposing the first portion, the second portion having a top wall, a third side wall, and a fourth side wall each extending along the longitudinal axis, and with the third side wall and the fourth side wall connected to the top wall to form a generally U-shaped cross section generally perpendicular to the longitudinal axis such that the third side wall and the fourth side wall extend from the top wall to a third distal edge and a fourth distal edge respectively;
wherein the first portion and the second portion at least partially abut and are attached together along the respective distal edges of their respective side walls at a first side joint and a second side joint to form a tubular structure extending along the longitudinal axis and defining a hollow interior region; and
wherein the first portion and the second portion are manufactured from a thermoplastic resin material reinforced with carbon fiber.

2. A cross member as set forth in claim 1 wherein at least one of the first portion and the second portion includes a wall thickness that varies simultaneously in both an axial direction along the longitudinal axis and a transverse direction perpendicular to the longitudinal axis.

3. A cross member as set forth in claim 1 wherein the wall thickness of the first portion and the second portion includes a maximum variation of ten millimeters (10 mm).

4. (canceled)

5. A cross member as set forth in claim 1 wherein a wall thickness of the bottom wall is different than a wall thickness of the first side wall and the second side wall of the first portion, and wherein a wall thickness of the top wall is different than a wall thickness of the third side wall and the fourth side wall of the second portion.

6. A cross member as set forth in claim 1 wherein:
the first distal edge of the first side wall of the first portion includes a first side flange extending outward and away from the hollow interior region, and the second distal edge of the second side wall of the first portion includes a second side flange extending outward and away from the hollow interior; and
the third distal edge of the third side wall of the second portion includes a third side flange extending outward and away from the hollow interior region, and the fourth distal edge of the fourth side wall of the second portion includes a fourth side flange extending outward and away from the hollow interior region;
wherein the first side flange, the second side flange, the third side flange, and the fourth side flange are arranged along their respective first, second, third, and fourth distal edges in contact with the opposing side flange to further define a first flange joint extending from the first side joint and a second flange joint extending from the second side joint.

7. A cross member as set forth in claim 6 wherein at least one of the first side flange, the second side flange, the third side flange, and the fourth side flange, include at least one flange ridge arranged to extend along at least one of the first and second flange joints.

8. A cross member as set forth in claim 6 further comprising a spacer disposed within at least one of the side walls and extending transverse to the longitudinal axis, wherein the spacer is made from a spacer material having greater compressive strength than the tubular structure.

9. A cross member as set forth in claim 8 wherein the spacer is disposed between the first portion and the second portion within a side wall opening defined by a concave section of the first and second side walls opposing a convex section defined by the third and fourth side walls.

10. A cross member as set forth in claim 1 wherein the first portion defines a first angle between the bottom wall and the first side wall of the first portion, and a second angle between the bottom wall and the second side wall of the first portion, wherein the second portion defines a third angle between the top wall and the third side wall of the second portion, and a fourth angle between the top wall and the fourth side wall of the second portion, and wherein each of the first angle, the second angle, the third angle, and the fourth angle are greater than ninety degrees (90°).

11. A cross member as set forth in claim 1 further comprising an insert disposed within at least one of the top and bottom walls extending transverse to the longitudinal axis, such that the insert includes a length perpendicular to the wall in which it is disposed that is equal to or greater than a wall thickness of that wall, and wherein the spacer is made from an insert material having greater compressive strength than the wall in which it is disposed.

12. A cross member as set forth in claim 11 wherein the insert defines an oblong opening having a long dimension perpendicular to the longitudinal axis and parallel with the top wall, and a short dimension that is parallel with the longitudinal axis and parallel with the top wall.

13. A cross member as set forth in claim 1 wherein the first portion and the second portion are attached together by one or a combination of an ultrasonic welding process, an adhesive bonding process, and a mechanical fastening process, a vibration welding process, a heat welding process, or a solvent welding process.

14. A cross member as set forth in claim 1 wherein the tubular structure includes at least one rib extending from at least one of the first portion and the second portion inward into the interior region.

15. A cross member as set forth in claim 1 wherein the first portion and the second portion are each individually manufactured from a compression molding process.

16. A cross member for an automotive chassis structure, the cross member comprising:
a first portion including a thermoplastic resin material reinforced with carbon fiber, extending along a longitudinal axis, and having a bottom wall, a first side wall, and a second side wall, with the first side wall and the second side wall extending from the bottom wall to form a generally U-shaped cross section generally perpendicular to the longitudinal axis, such that the first side wall and the second side wall extend from the bottom wall to a first distal edge and a second distal edge respectively; and
a second portion, including a thermoplastic resin material reinforced with carbon fiber, extending along the longitudinal axis, and having a top wall, a third side wall, and a fourth side wall, with the third side wall and the second side wall extending from the top wall to form a generally U-shaped cross section generally perpendicular to the longitudinal axis, such that the third side wall and the fourth side wall extend from the top wall to a third distal edge and a fourth distal edge respectively;
wherein the first portion and the second portion are attached together along the first distal edge and the third distal edge of the first side wall and the third side wall respectively, and along the second distal edge and the fourth distal edge of the second side wall and the fourth side wall respectively, to define a tubular structure extending along the longitudinal axis and having a hollow interior region;
wherein at least one of the first portion and the second portion includes a wall thickness that varies simultaneously in both an axial direction along the longitudinal axis and a transverse direction perpendicular to the longitudinal axis, between a minimum thickness of one and one half millimeters (1.5 mm) and a maximum thickness of eleven and one half millimeters (11.5 mm); and
wherein the tubular structure includes at least one rib extending from at least one of the first portion and the second portion inward into the interior region.

17. (canceled)

18. A cross member as set forth in claim 16 wherein a wall thickness of the bottom wall is different than a wall thickness of the first side wall and the second side wall of the first portion, and wherein a wall thickness of the top wall is different than a wall thickness of the third side wall and the fourth side wall of the second portion.

19. A cross member as set forth in claim 16 further comprising an insert disposed within at least one of the top wall and the bottom wall, and extending transverse to the longitudinal axis, such that the insert includes a length perpendicular to the wall in which the insert is disposed that is greater than a wall thickness of that wall, and wherein the insert is made from an insert material having greater compressive strength than the wall in which the insert is disposed.

20. A cross member as set forth in claim 16 further comprising a spacer disposed within at least one of the side walls and extending transverse to the longitudinal axis, wherein the spacer is made from a spacer material having greater compressive strength than the tubular structure.

21. A cross member as set forth in claim 7 wherein the at least one flange ridge includes a plurality of flange ridges defining at least one channel therebetween extending along the first and second flange joints.

22. A cross member as set forth in claim 21 further comprising an adhesive disposed within the at least one channel for bonding the first portion and the second portion together.

23. A cross member as set forth in claim 7 wherein the at least one flange ridge spaces opposing surfaces, of at least one of the first and second flange joints, apart to define a gap therebetween.

24. A cross member as set forth in claim 23 further comprising an adhesive disposed within the gap, between the first portion and the second portion.

25. A cross member as set forth in claim 7 wherein the at least one flange ridge is welded to an opposing flange.

26. A cross member as set forth in claim 9 wherein at least one of the convex sections and the concave sections include at least one spacer ridge for engaging the spacer to strengthen the attachment between the first portion and the spacer, and between the second portion and the spacer.
